(19) United States
(12) Patent Application Publication
(10) Pub. No.: US 2025/0173659 A1
(43) Pub. Date: May 29, 2025

(54) PLAN ANALYSIS METHOD AND PLAN ANALYSIS SYSTEM

(71) Applicant: Hitachi, Ltd., Tokyo (JP)

(72) Inventors: Yuta TSUCHIYA, Tokyo (JP); Masaki HAMAMOTO, Tokyo (JP)

(21) Appl. No.: 18/916,460

(22) Filed: Oct. 15, 2024

(30) Foreign Application Priority Data
Nov. 24, 2023 (JP) 2023-199393

(51) Int. Cl. G06Q 10/0637

(52) U.S. Cl. CPC G06Q 10/0637

(57) ABSTRACT

In a plan analysis method for analyzing an optimal plan in which an optimization target is optimized based on a plurality of constraints and evaluation indices, the plan analysis system generates a plurality of optimization patterns by combining constraints to be analyzed. Further, for each of the optimization patterns, an upper bound based on the evaluation indices when a condition corresponding to a focus state that a user pays attention to in the optimal plan is satisfied and the upper bound when the condition is not satisfied are calculated. Further, an executable solution for the optimization under each of the conditions is searched. Further, based on the upper bound and the executable solution, whether an optimal solution for the optimization is present under the conditions is determined.

### CROSS REFERENCE TO RELATED APPLICATIONS

This application claims priority based on Japanese patent application No. 2023-199393, filed on Nov. 24, 2023, the entire contents of which are incorporated herein by reference.

### BACKGROUND OF THE INVENTION

### 1. Field of the Invention

The present invention relates to a plan analysis method and a plan analysis system.

### 2. Description of Related Art

As the progress of digitalization, all pieces of information are converted into data, and an optimization engine and an agent-based simulation are now being used for important life-changing decision-making, such as optimizing human resource allocation.

On the other hand, the optimization engine merely presents a solution for maximizing an objective function, and cannot present reasons for the allocation of plan elements, such as, for example, when it comes to human resource allocation, “person A is more suited to a workplace 2 than a workplace 1, so why is he assigned to the workplace 1?” In business that involves a great deal of social responsibility, it is important to present not only the optimization results but also descriptions that satisfy a user.

In recent years, a research into explainable AI Planning (XAIP), which is a technique that describes a basis for determination made in an optimal plan, is progressed rapidly.

As a technique classified into XAIP, in NPL 1, a method for clarifying a contribution of an attribute or a constraint, which is an input factor, to the establishment of a certain element of a plan, and for describing main causes by focusing on the phenomenon.

However, in order to present the plan basis, it is necessary to perform sensitivity analysis in which the input factor is perturbed and the optimization problem is solved multiple times. This requires a large amount of calculation cost, and requires the user to wait for a long time to see the description.

On the other hand, NPL 1 proposes a method in which a hierarchical relationship between the input factors is input, allowing a quick grasp of an overall tendency at a higher level, and then factors that are expected to have a high contribution degree are analyzed at a lower level. The number of combinations of factors that are perturbed at each level can be reduced, enabling efficient factor search.

NPL 2 proposes a method for sampling a combination of perturbations. In the calculation of a contribution degree based on a Shapley value, a tendency for an influence of a single factor (main effect) to indicate a large value as the contribution degree is utilized, thereby narrowing down the number of combinations required for the calculation and obtaining a highly accurate approximate solution.

In addition, PTL 1 proposes a method for efficiently searching for a solution in a branch-and-bound method, which is mainstream in optimization calculation, by determining a degree of difficulty of the calculation when deciding which branch to search and dividing the problem according to the result.

In addition, PTL 2 proposes a technique for enabling shortening in a search processing time and reduction in an amount of memory necessary for the search processing, by using the already detected solution information. When solving the same optimization problem multiple times, it is possible to omit unnecessary searches by reusing a solution obtained in the past.

### CITATION LIST

### Patent Literature

PTL 1: JP2004-133802A
PTL 2: JPH7-319848A

### Non Patent Literature

NPL 1: Y. Tsuchiya, M. Hamamoto, “Explanation Framework for Optimization-Based Scheduling: Evaluating Contributions of Constraints and Parameters by Shapley Values,” International Workshop on Human-Aware and Explainable Planning (HAXP), 2023.
NPL 2: M. Scott Lundberg, Su-In Lee, “A Unified Approach to Interpreting Model Predictions,” In Proceedings of the 31st International Conference on Neural Information Processing Systems, 4768-4777, 2017.

### SUMMARY OF THE INVENTION

The techniques disclosed in NPL 1 and NPL 2 contribute to reducing the number of combinations of calculations in the sensitivity analysis of the input factor. However, the hierarchization of the input factor in NPL 1 requires prior domain knowledge in the optimization problem and is difficult to use for a general user who does not have the domain knowledge to utilize.

The technique disclosed in NPL 2 can efficiently obtain an approximate solution, but requires at least about 1000 calculations for a combination of about 20 input factors, for example. The optimization problem often requires several hours for a single calculation, and it may be difficult to improve efficiency of calculating the plan basis simply by reducing the number of combinations.

The techniques described in PTL 1 and PTL 2 contribute to increasing a speed of calculation of each perturbation.

However, since the technique disclosed in PTL 1 is a technique to be applied to a general problem setting, there is room for further speed improvement in problem setting when calculating the plan basis.

The technique disclosed in PTL 2 is effective in the case of performing repeated optimization calculations because past calculation results are reused. However, in the technique disclosed in PTL 2, when the problem setting itself changes by replacing the input factor, it is difficult to reuse the past calculation result.

The invention has been made in view of the above circumstances, and an object of the present invention is to quickly execute analysis of an optimal plan without requiring prior domain knowledge related to a planning target.

According to an aspect of the invention, provided is a plan analysis method to be executed by a plan analysis system that analyzes an optimal plan in which an optimization target is optimized based on a plurality of constraints and evaluation indices, the plan analysis system including a processor and a memory, the plan analysis method includes the processor executing the following processing: generating a plurality of optimization patterns by combining the constraints to be analyzed; calculating, for each of the optimization patterns, an upper bound based on the evaluation indices when a condition corresponding to a focus state that a user pays attention to in the optimal plan is satisfied and the upper bound when the condition is not satisfied; searching for an executable solution for the optimization under each of the conditions; and determining, based on the upper bound and the executable solution, whether an optimal solution for the optimization is present under the conditions.

According to the invention, it is possible to quickly execute the analysis of the optimal plan without requiring the prior domain knowledge related to the planning target.

### BRIEF DESCRIPTION OF THE DRAWINGS

FIG. 1 is a diagram showing an example of a system configuration of a plan analysis system according to Embodiment 1;

FIG. 2 is a block diagram showing an example of a functional configuration of the plan analysis system according to Embodiment 1;

FIG. 3 is a diagram showing an example of a data structure of a plan information master according to Embodiment 1;

FIG. 4 is a diagram showing an example of a data structure of question data and a search initial condition according to Embodiment 1;

FIG. 5 is a diagram showing an example of a data structure of analysis target data and an optimization pattern according to Embodiment 1;

FIG. 6 is a diagram showing an example of a data structure of an upper bound according to Embodiment 1;

FIG. 7 is a diagram showing an example of a data structure of an executable solution according to Embodiment 1;

FIG. 8 is a diagram showing an example of a data structure of contribution degree calculation data and contribution degree data according to Embodiment 1;

FIG. 9 is a diagram showing an example of a flowchart showing description generation processing based on the upper bound according to Embodiment 1;

FIG. 10 is a diagram showing an outline of condition determination based on the upper bound according to Embodiment 1;

FIG. 11 is a diagram showing an example of an input and output screen according to Embodiment 1;

FIG. 12 is a diagram showing an example of a system configuration of a plan analysis system that enables utilization of a provisional solution and generation of an approximate description according to Embodiment 2;

FIG. 13 is a block diagram showing an example of a functional configuration of the plan analysis system according to Embodiment 2;

FIG. 14 is a diagram showing an example of a data structure of a search completion condition according to Embodiment 2;

FIG. 15 is a diagram showing an example of a flowchart showing description generation processing based on an upper bound according to Embodiment 2;

FIG. 16 is a diagram showing an example of a system configuration of a plan analysis system according to Embodiment 3;

FIG. 17 is a block diagram showing an example of a functional configuration of the plan analysis system according to Embodiment 3; and

FIG. 18 is a diagram showing an example of a flowchart showing description generation processing according to Embodiment 3.

### DESCRIPTION OF EMBODIMENTS

Hereinafter, embodiments according to the present disclosure will be described with reference to the drawings. However, the embodiments are merely examples for implementing the technique of the present disclosure and do not limit the technical scope of the present disclosure. It will be easily understood by those skilled in the art that the specific configuration is changed without departing from the technical idea or gist of the present disclosure and that the embodiments and the modifications thereof can be combined.

In the following embodiments, the same or similar configurations or functions are denoted by the same reference numerals, and redundant description is omitted. In addition, when elements of the same type are described without being distinguished, a common reference numeral may be used, and when elements of the same type are distinguished and described, reference numerals may be used.

In the following embodiments, a staff allocation plan for allocating a staff to an appropriate workplace will be described. However, the invention is not limited thereto, and can be widely applied to a system that creates and updates a plan by combining various evaluation viewpoints and constraint conditions such as an operation plan of a transportation facility such as an aircraft, a bus, and a railway, a product manufacturing plan in a factory, and a simulation of a supply chain.

In the following embodiments, a maximization problem based on an integer linear programming method using the branch-and-bound method is taken as an example. However, the invention is not limited thereto. If there is a problem that can calculate an upper bound by solving a relaxation problem, it is also possible to easily apply to a minimization problem by inverting a sign of a numerical value to be calculated without depending on a specific optimization calculation procedure.

In addition, in the following embodiments, an example will be shown in which the optimization target are staff such as employees and allocation quotas such as workplaces, and a main constraint that influences a question from a user “why was an employee allocated to a certain workplace?” is narrowed down. However, the invention is not limited thereto, and can be applied not only to binary questions such as “a condition is satisfied or not satisfied” but also to questions in which multiple conditions are designated. In addition, not only the constraint but also an input factor of attribute information can be used.

In the following description, “central processing unit (CPU)” is an example of one or more processor devices. The processor device is typically not limited to the CPU, and may be a different type of processor device such as a graphics processing unit (GPU). At least one processor device may be a single core or a multi-core. At least one processor device may be a processor core.

At least one processor device may be a circuit that is an aggregate of gate arrays in a hardware description language that performs a part or all of the processing. The circuit is a processor device in a broad sense, such as a field-programmable gate array (FPGA), complex programmable logic device (CPLD), or application specific integrated circuit (ASIC).

In the following description, processing mainly includes an “yyy program”. In this case, the program is executed by the CPU to implement a processing function called an “yyy functional unit” and becomes an executing entity of the processing. The processing function may be implemented when one or more computer programs are executed by a processor, may be implemented by one or more hardware circuits (for example, an FPGA or an ASIC), or may be implemented by a combination thereof.

When a function is implemented by executing a program by a processor, the function may be at least a part of the processor as specified processing is executed using a storage device and/or an interface device as appropriate. Processing described with a functional unit as a subject may be processing executed by a processor or a device including the processor.

The program may be installed from a program source. The program source may be, for example,, a program distribution computer or a computer-readable recording medium (for example, a non-transitory recording medium). The description of the functions is an example, and a plurality of functions may be integrated into one function, or one function may be divided into a plurality of functions. The “yyy functional unit” may be referred to as an “yyy unit”.

Although various kinds of information may be described in a table format in the following embodiments, the data format of the information may be a format other than the table format (for example, comma separated values (CSV) format).

### Embodiment 1

### Configuration of Plan Analysis System 1 According to Embodiment 1

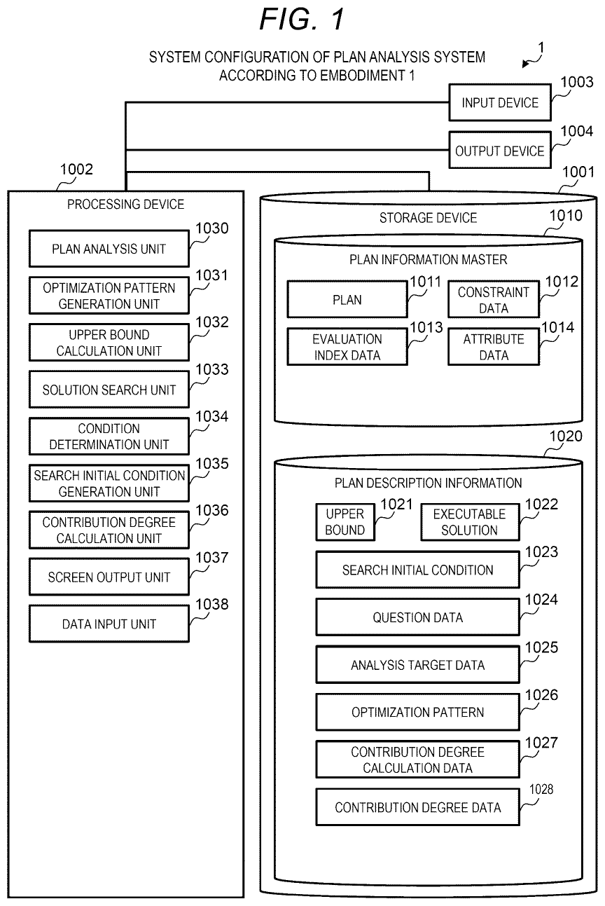

FIG. 1 is a diagram showing an example of a system configuration of the plan analysis system 1 according to Embodiment 1.

The plan analysis system 1 includes a storage device 1001, a processing device 1002, an input device 1003, and an output device 1004.

The storage device 1001 is a general-purpose device that permanently stores data such as a hard disk drive (HDD) and a solid-state drive (SSD), and stores a plan information master 1010 and a plan description information 1020. The storage device 1001 may be implemented to be present on a cloud or an external server and to refer to data via a network.

The plan information master 1010 includes a plan 1011 proposed by an optimization solver and simulation, constraint data 1012 storing information on a constraint, evaluation index data 1013 indicating a key performance indicator (KPI) of a plan, and attribute data 1014 related to a plan element.

The plan description information 1020 includes an upper bound 1021 obtained by solving a relaxation problem of an optimization problem, an executable solution 1022 obtained in a solution search process, a search initial condition 1023 based on a state that a user is focusing on (focus state), and question data 1024 for the plan from the user. The plan description information 1020 includes analysis target data 1025 that is a cause candidate for a question element, an optimization pattern 1026 obtained by converting an attribute or a constraint of an analysis target, and contribution degree calculation data 1027 obtained from a result of a question and a solution search. The plan description information 1020 includes contribution degree data 1028 to be analyzed.

The processing device 1002 is a general-purpose computer including a processor such as a CPU and a memory. The processing device 1002 includes a plan analysis unit 1030, an optimization pattern generation unit 1031, an upper bound calculation unit 1032, a solution search unit 1033, a condition determination unit 1034, a search initial condition generation unit 1035, a contribution degree calculation unit 1036, a screen output unit 1037, and a data input unit 1038. The processing device 1002 implements the processing functional units by executing programs stored in the memory.

The screen output unit 1037 converts the data stored in the plan information master 1010 or the plan description information 1020 into a display output format and outputs the data to a display. The data input unit 1038 receives and sets a parameter and an input of a question from the user.

The input device 1003 is, for example, a mouse, a keyboard, or a touch panel. The output device 1004 is a display or the like, and information is displayed for the user via the screen output unit 1037. However, if there is no need for a human to check an evaluation result of a machine learning system (for example, if the evaluation result is passed directly to another system), the output device can be omitted.

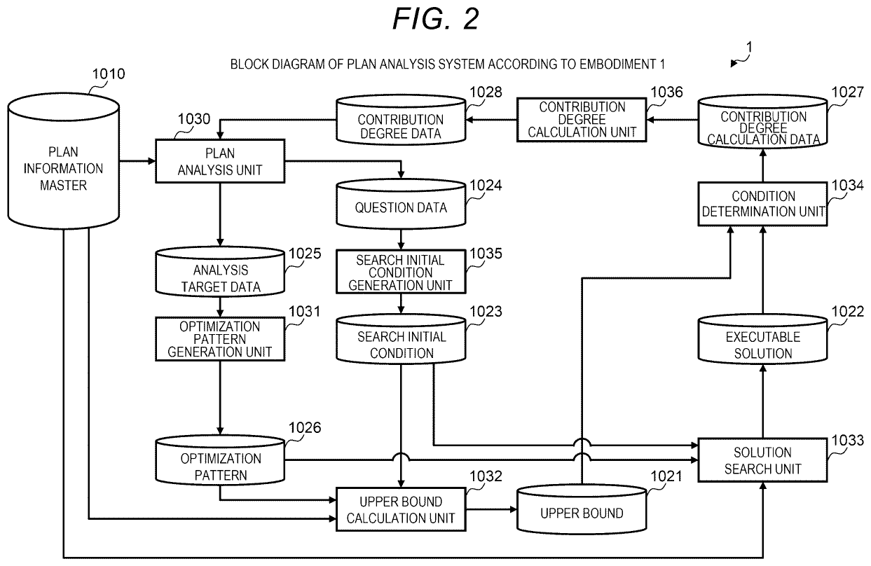

FIG. 2 is a block diagram showing an example of a functional configuration of the plan analysis system 1 according to Embodiment 1.

The plan analysis unit 1030 generates the question data 1024 and the analysis target data 1025 based on a question from the user for the plan 1011 extracted from the plan information master 1010. The optimization pattern generation unit 1031 converts the analysis target data 1025 into the optimization pattern 1026. The search initial condition generation unit 1035 outputs the search initial condition 1023 of the upper bound and the executable solution based on the question data 1024.

The upper bound calculation unit 1032 calculates the upper bound 1021 of the search initial condition 1023 for the certain optimization pattern 1026 based on the plan information master 1010. The solution search unit 1033 searches for the executable solution 1022 of each search initial condition 1023 for the certain optimization pattern 1026 based on the plan information master 1010.

The condition determination unit 1034 determines whether an optimal solution is included in a focus state condition based on the obtained upper bound 1021 and the executable solution 1022, and outputs the optimal solution to the contribution degree calculation data 1027 when it is determined that the optimal solution is included. After elements of the contribution degree calculation data 1027 for all the optimization patterns 1026 are obtained, the contribution degree calculation unit 1036 calculates the contribution degree data 1028 of each analysis target based on the contribution degree calculation data 1027. The obtained contribution degree data 1028 is input to the plan analysis unit 1030 and presented to the user.

### Plan Information Master 1010 According to Embodiment 1

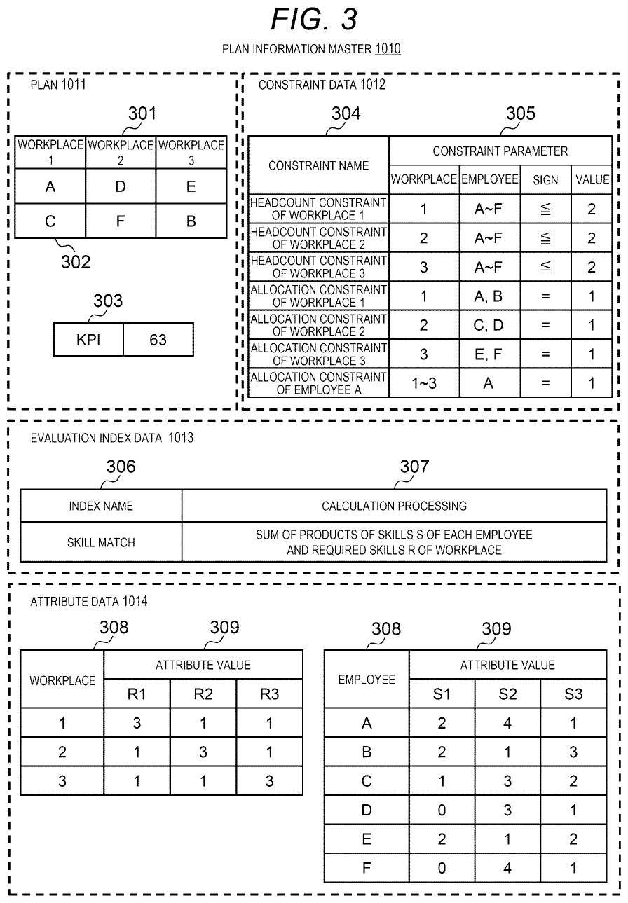

FIG. 3 is a diagram showing an example of a data structure of the plan information master 1010 according to Embodiment 1.

The plan information master 1010 includes the plan 1011, the constraint data 1012, the evaluation index data 1013, and the attribute data 1014.

The plan 1011 includes matrix data (table data) as an example, and includes plan basic information 301, an element 302, and a KPI 303. The plan basic information 301 is a target for allocating the element 302, such as workplace quotas for staff allocation. The element 302 is a determination variable for optimization, such as a staff during staff allocation.

The plan targeted by the present embodiment is not limited thereto, and may be a route plan, a train operation plan diagram, or the like. In the operation plan, for example, the element 302 is a train name, the plan basic information 301 is a station, forming a table of time frames. There is also a case in which the plan basic information 301 is not present and only a set of the elements 302 is treated as the plan 1011. The KPI 303 represents an objective function or a KPI value of the plan 1011.

The constraint data 1012 includes columns of a constraint name 304 and a constraint parameter 305. The constraint parameter 305 used as an optimization condition, and a relationship between the plan basic information 301 and the element 302 is indicated by a sign and a value. For example, a headcount constraint of a workplace 1 indicates that only two of employees A through F can be allocated to the workplace 1. However, the constraint condition is not limited thereto, and may be a case in which a weight based on the attribute data 1014 is added or a case in which the constraint is given by a formula instead of the table format.

The evaluation index data 1013 includes information of a KPI for the purpose of plan optimization, and includes columns of an index name 306 and calculation processing 307. A plurality of KPIs may be present in one problem.

The attribute data 1014 includes columns of an attribute attribution destination 308 and an attribute value 309. The attribute attribution destination 308 corresponds to the plan basic information 301 and the element 302. In the present embodiment, the plan basic information 301 includes “employees” who are allocation targets, and “workplaces” which are allocation quotas for the allocation targets. The attribute value 309 represents a KPI and a parameter that acts on a constraint of the plan optimization for each attribute attribution destination 308.

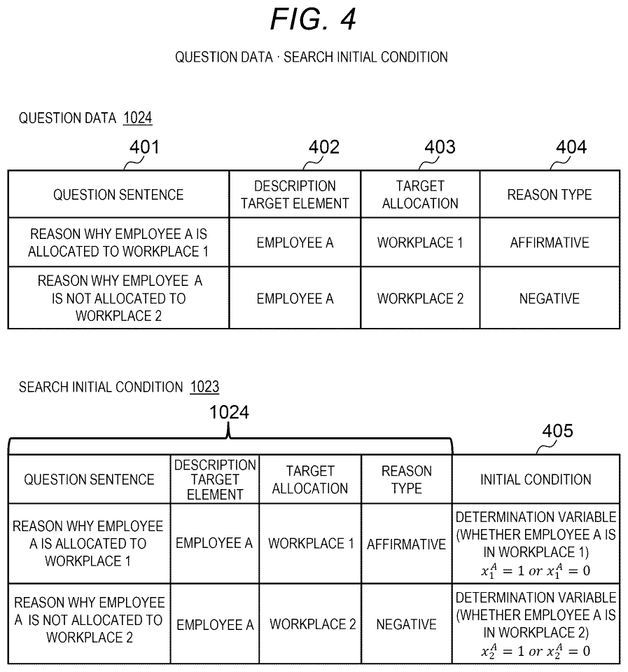

FIG. 4 is a diagram showing an example of data structures of the question data 1024 and the search initial condition 1023 according to Embodiment 1.

The question data 1024 includes columns of a question sentence 401 input from the user, a description target element 402, a target allocation 403, and a reason type 404. When the question sentence 401 is input from the user, the description target element 402, the target allocation 403, and the reason type 404 corresponding thereto are created by the plan analysis unit 1030. The description target element 402, the target allocation 403, and the reason type 404 may be input by the user.

In the description target element 402, one or a plurality of elements 302 are extracted. The target allocation 403 indicates the plan basic information 301 corresponding to the description target element 402. The reason type 404 indicates whether the question sentence 401 is questioned about a condition that is true (affirmative) or a condition that is not true (negative) regarding the description target element 402.

The search initial condition 1023 is information in which the initial condition 405 is given to the question data 1024 by the search initial condition generation unit 1035. The initial condition 405 represents a specific condition under which the content of the question sentence 401 is satisfied. A description method is not limited to a natural language, and may also be a conditional expression or a programming language.

For example, when the question sentence 401 is “reason why the employee A is allocated to the workplace 1”, the description target element 402 is the employee A, the target allocation 403 is the workplace 1, the reason type 404 is affirmative, and the initial condition 405 satisfies a conditional expression “x₁^{A}=1 or x₁^{A}=0”. As a simple extension, questions with a plurality of conditions can also be defined, such as “why is the employee A allocated to the workplace 1 and the workplace 2?” or “why are the employees A and B allocated to the workplace 1?” In addition to human resource allocation, the method can also be applied to questions such as “why does train A depart at this time?” in a train diagram, or questions such as “why turn right at this corner?” in a route plan. The method can also be applied to continuous values by converting them into a conditional expression that specifies a range of values.

### Analysis Target Data 1025 and Optimization Pattern 1026 According to Embodiment 1

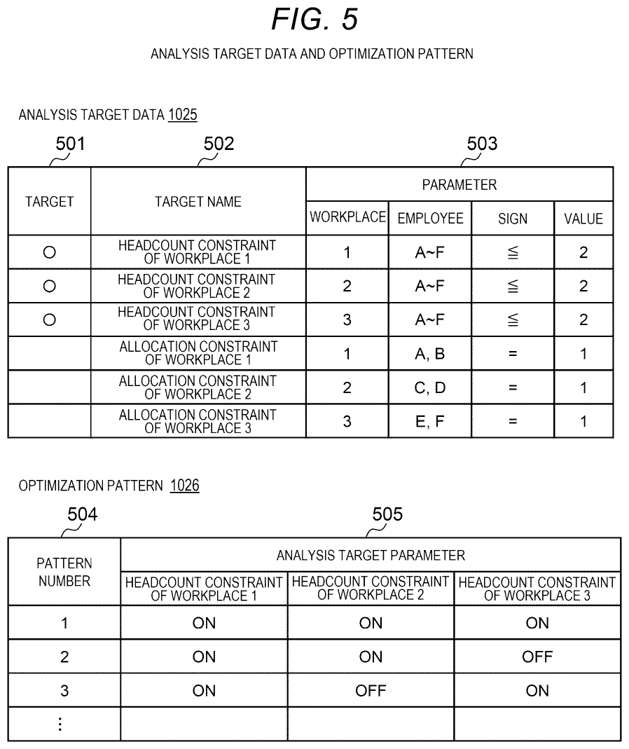

FIG. 5 is a diagram showing an example of data structures of the analysis target data 1025 and the optimization pattern 1026 according to Embodiment 1.

The analysis target data 1025 includes columns of target information 501 indicating whether it is an analysis target, a target name 502, and a parameter 503 indicating whether an analysis target is to be analyzed. The target information 501 is designated by the user via the plan analysis unit 1030. When the analysis target is the constraint, the target name 502 and the parameter 503 indicate the constraint name 304 and the constraint parameter 305 of the constraint data 1012, respectively. When the analysis target is the attribute, the parameter 503 indicates the attribute attribution destination 308 and the attribute value 309, and the target name 502 is designated by the plan analysis unit 1030. When the analysis target is the attribute, the attribute value can be regarded as a type of the constraint.

The optimization pattern 1026 is generated from the analysis target data 1025 by the optimization pattern generation unit 1031, and includes columns of a pattern number 504 and an analysis target parameter 505. The analysis target parameter 505 indicates a combination of whether to use a base line (a value that has no effect on the plan for each analysis target) or an original parameter for the analysis target data 1025 designated in the target information 501. For example, a value corresponding to “no constraint” in the constraint is input as a base line, and an average of all targets is input in the attribute value (skill attribute of staff, performance value of device, or the like). Basically, a combination of all ON (base line)/OFF (original parameters) is prepared the optimization pattern 1026, but this is not the case in which an existing approximation calculation method is used in combination.

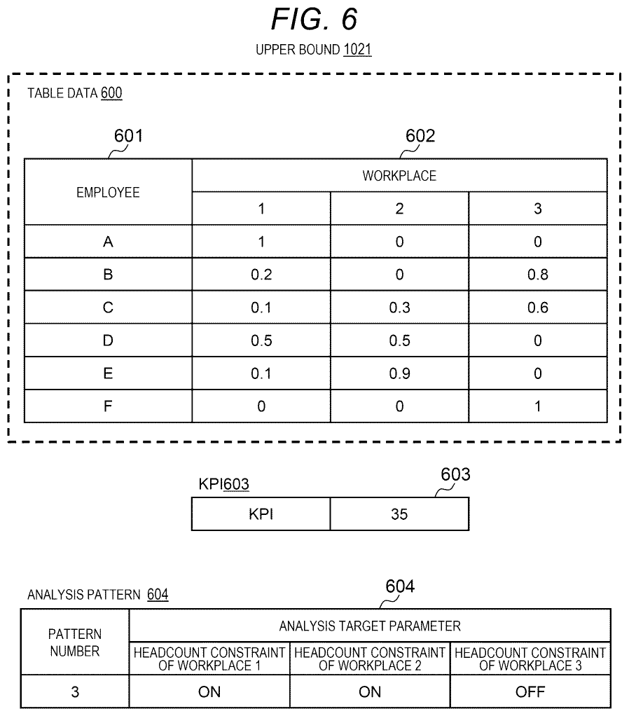

FIG. 6 is a diagram showing an example of a data structure of the upper bound 1021 according to Embodiment 1.

The upper bound 1021 includes an element 601, plan basic information 602, a KPI 603, and an analysis pattern 604. Here, the upper bound 1021 indicates a solution obtained from a problem (relaxation problem) in which an input factor (problem setting) that is not an analysis target is relaxed in the target optimization problem.

For example, a linear programming method in which an integer constraint of a variable is removed is cited as a relaxation problem of the integer linear programming method. The upper bound 1021 has a feature that when the relaxed solution of the linear programming method is compared to a solution of an original optimization problem that is not relaxed, “the KPI 603 is equal to or greater than the solution of the original optimization problem that is not relaxed”. The solution having the feature is not limited to the relaxation problem as long as the solution is calculated.

Here, table data 600 including the element 601 and the plan basic information 602 indicates the solution of the relaxation problem. In the example,, it shows which workplace each employee is allocated to. Since the integer constraint related to the allocation of the employees is relaxed, one employee is allocated to a plurality of workplaces.

When there is the element 601 partially fixed in the search process of the solution search unit 1033, the fixed element 601 and the element 601 obtained by the optimization calculation are distinguished. The KPI 603 indicates a value of an objective function or KPI corresponding to the solution. The analysis pattern 604 indicates a combination of input factors such as constraint conditions which are the analysis targets.

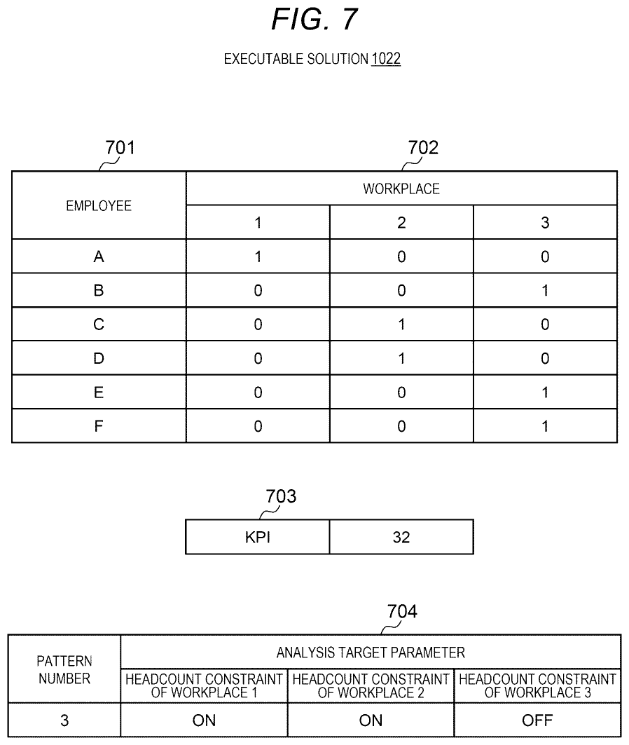

FIG. 7 is a diagram showing an example of a data structure of the executable solution 1022 according to Embodiment 1. The executable solution 1022 includes an element 701, plan basic information 702, a KPI 703, and an analysis parameter 704. Although the data configuration of the executable solution 1022 is the same as that of the upper bound 1021 (FIG. 6), the executable solution 1022 is a solution that does not relax the input factor, and is a solution that can be executed under the constraint condition of the original optimization problem. In the example, it is shown that the allocation of each employee is fixed at 0 or 1, satisfying the integer constraint.

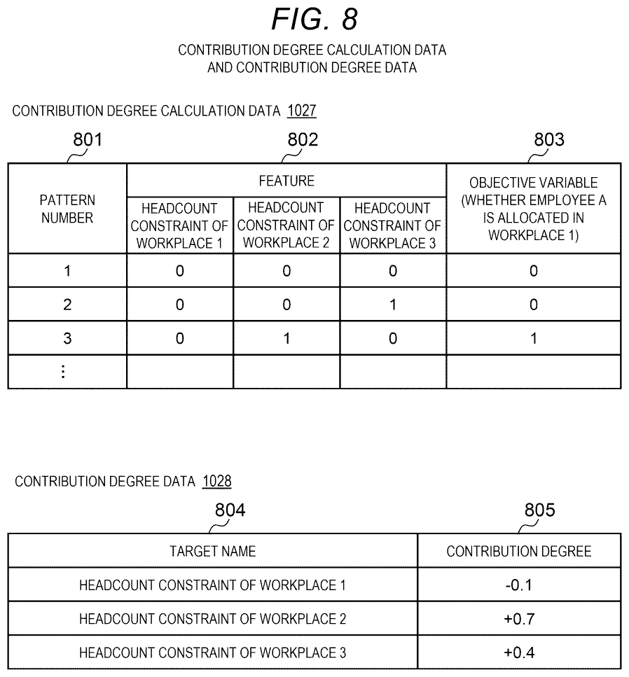

FIG. 8 is a diagram showing an example of data structures of the contribution degree calculation data 1027 and the contribution degree data 1028 according to Embodiment 1.

The contribution degree calculation data 1027 includes a pattern number 801, a feature 802, and an objective variable 803. The pattern number 801 is the same as the pattern number 504 of the optimization pattern 1026 (FIG. 5). Column names of the feature 802 corresponds to the column names of the analysis target parameter 505 of the optimization pattern 1026 (FIG. 5). The feature 802 indicates whether the analysis target parameter 505 in the optimization pattern 1026 (FIG. 5) is a base line (0) or an original parameter (1).

The objective variable 803 is a determination result of the condition determination unit 1034 for the optimization pattern corresponding to each pattern number 801, and indicates whether the initial condition 405 of a question (focus state) is satisfied (1) or not satisfied (0) in an optimal solution.

The contribution degree data 1028 includes columns of a target name 804 and a contribution degree 805. The target name 804 corresponds to the target name 502 designated by the target information 501 in the analysis target data 1025 (FIG. 5). The contribution degree 805 is calculated by the contribution degree calculation unit 1036, and indicates an influence of a target identified by the target name 804 on “satisfying the condition of the question”. The contribution degree 805 indicates an influence on “satisfying the condition of the question” with a positive value, and an influence on “not satisfying the condition of the question” with a negative value, and a magnitude of the influence with an absolute value.

### Flowchart Showing Description Generation Processing Based on Upper Bound 1021 According to Embodiment 1

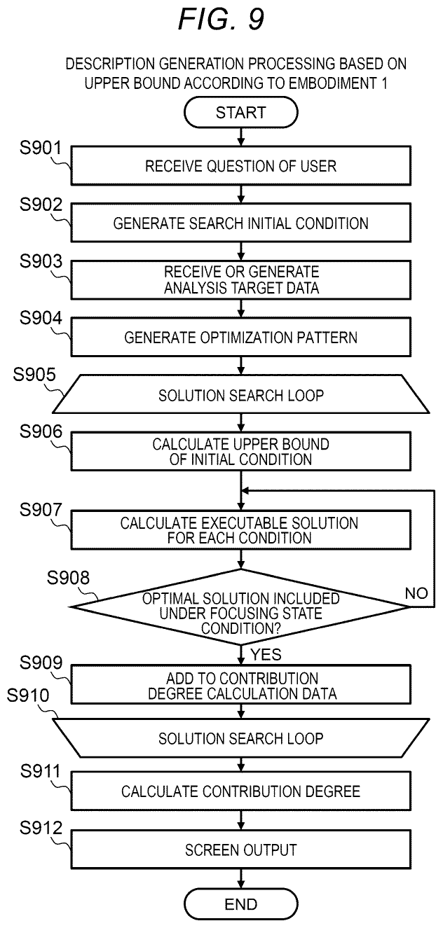

FIG. 9 is a diagram showing an example of a flowchart showing description generation processing based on the upper bound 1021 according to Embodiment 1.

In the description generation processing, in order to clarify a main cause for satisfaction of a focus state condition of the user in a plan, a description is generated based on the contribution degree of the input factor. In the present embodiment, based on a search condition matching the question from the user, the contribution degree of each analysis target is calculated based on a search result of the upper bound and the executable solution fora combination of the analysis target data. The description generation processing is executed when a question to the optimal plan is input by the user via the input device 1003 (FIG. 1).

Step S901: The plan analysis unit 1030 receives, via the input device 1003, an input of the question sentence 401 or the question data 1024 related to a question of the user corresponding to the plan 1011. When the question sentence 401 is input, the plan analysis unit 1030 generates the question data 1024 based on the question sentence 401. The plan analysis unit 1030 converts the question sentence 401 into the question data 1024 using conversion based on an input to an interface in the form of the conditional expression or a fill-in-the-blank format, or an existing natural language processing technique.

Step S902: The search initial condition generation unit 1035 generates the search initial condition 1023 based on the question data 1024. The initial condition 405 is generated using the existing conditional expression, fill-in-the-blank, or the like.

Step S903: The plan analysis unit 1030 receives upload of the analysis target data 1025 by the user. The plan analysis unit 1030 generates the analysis target data 1025 that reflects in the target information 501 a selection of a plurality of constraints input by the user via the input device 1003 from a list of input factors displayed on the screen of the output device 1004.

Step S904: The optimization pattern generation unit 1031 converts the analysis target data 1025 into the optimization pattern 1026. Specifically, the optimization pattern generation unit 1031 outputs, as the analysis target parameter 505, a combination of which of the base line or the original parameter present in the plan information master 1010 is used for the analysis target data 1025 designated by the target information 501. Basically, although all combinations (for example, for three analysis targets, there are 8 possibilities, which is obtained by 2\hat{ }3) are output, random pattern generation and Monte Carlo sampling may be performed from the viewpoint of the calculation amount.

Step S905: A solution search loop of steps S906 to S910 is executed for each row of the optimization pattern 1026.

Step S906: The upper bound calculation unit 1032 calculates the upper bound 1021 for the search initial condition 1023 based on the plan information master 1010. For example, as shown in FIG. 6, the linear programming method excluding an integer constraint of variables is formulated as the relaxation problem of the integer linear programming method, and the upper bound 1021 is calculated. Here, the upper bound calculation unit 1032 performs the optimization calculation in a state in which the variable corresponding to the search initial condition 1023 is fixed.

In the example of FIG. 4, in order to analyze the “reason why the employee A is allocated to the workplace 1”, a value of a “determination variable indicating whether the employee A is in the workplace 1” is designated in the initial condition 405. The upper bound calculation unit 1032 formulates the relaxation problem and calculates the upper bound 1021 for each of the initial conditions 405.

Step S907: The solution search unit 1033 searches for the executable solution 1022 in each search initial condition 1023 based on the plan information master 1010. Although the search method is not designated, the branch-and-bound method is generally used in the integer linear programming method. This is a method for efficiently searching by repeatedly calculating the relaxation problem while fixing variables to obtain the upper bound, thereby terminating problems that do not contain an optimal solution through a bounding operation. The relaxation problem usually leads to faster optimization calculation, and the linear programming method can be calculated on the order of polynomials. Such a search method is executed under each search initial condition 1023.

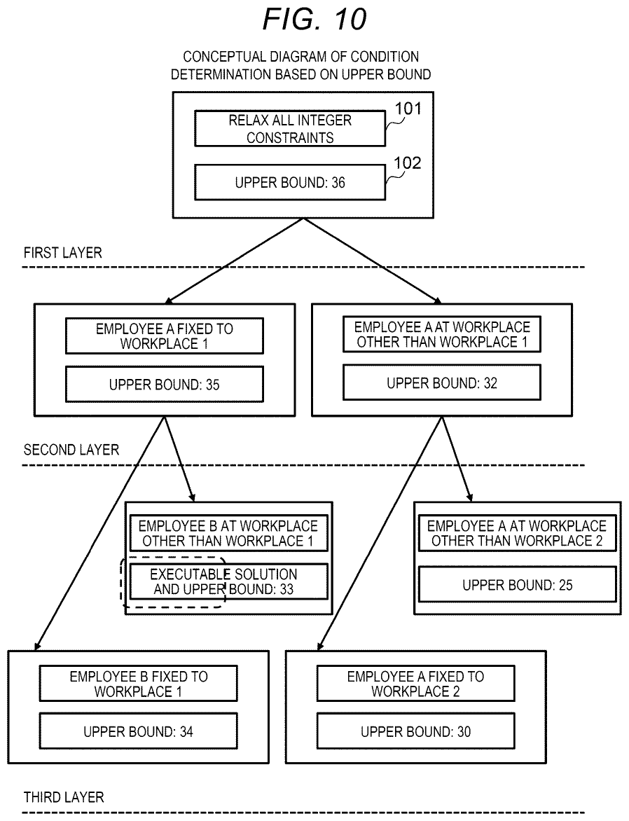

Step S908: The condition determination unit 1034 determines whether an optimal solution is included in the focus state condition based on the obtained upper bound 1021 and the executable solution 1022. Specifically, the condition determination unit 1034 performs the following processing when the executable solution under a certain search initial condition 1023 (for example: the employee A is allocated to the workplace 1) is found in step S907. That is, when an objective function value is larger than the upper bound of another search initial condition 1023 (for example: the employee A is not allocated to the workplace 1) (YES in step S908), it is determined that the optimal solution is under the condition that “the employee A is allocated to the workplace 1”. Therefore, the processing proceeds to step S909. A detailed specific example will be described later with reference to FIG. 10.

On the other hand, when the executable solution is still smaller than the upper bound and the condition of the optimal solution cannot be determined (NO in step S908), the condition determination unit 1034 returns the processing to step S907 to continue the search for the executable solution.

Step S909: The condition determination unit 1034 reflects the result determined in step S908 in the contribution degree calculation data 1027. The pattern number 801 and the feature 802 are reflected from row information of the optimization pattern 1026. The objective variable 803 stores 1 when the optimal solution is included in the focus state (question sentence 401) condition and 0 when the optimal solution is not.

Step S910: When the generation of the contribution degree calculation data 1027 is completed by executing steps S906 to S909 on all the optimization patterns 1026, the processing proceeds to step S911.

Step S911: The contribution degree calculation unit 1036 calculates the contribution degree data 1028 for each analysis target based on the contribution degree calculation data 1027. The target name 804 is obtained from the column name of the feature 802. An existing method is used to calculate the contribution degree. For example, examples include calculation of the contribution degree based on a Shapley value, which is commonly used in game theory, and calculation of the contribution degree based on a Cohort Shapley value, which can take into account dependency between factors.

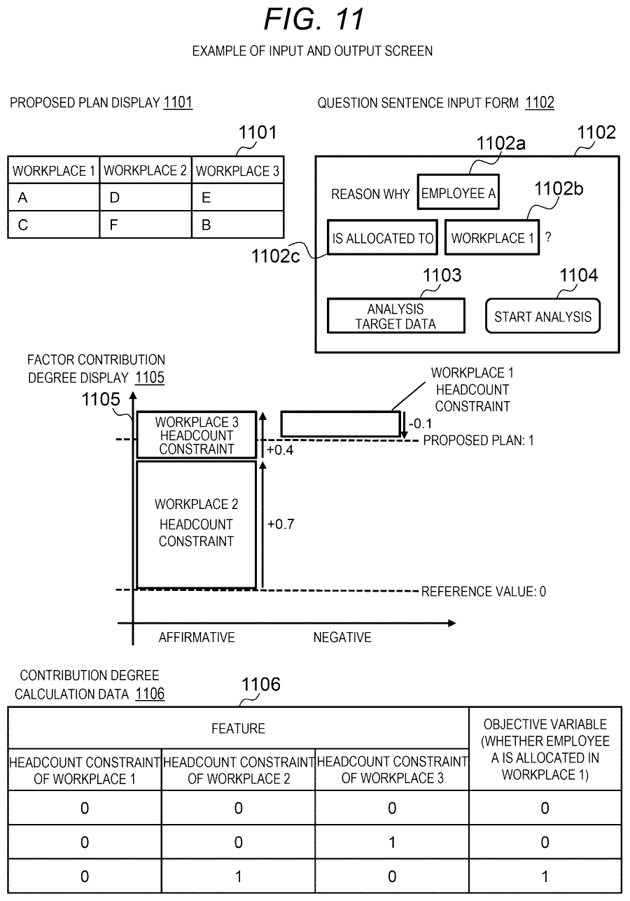

Step S912: The plan analysis unit 1030 performs processing such as graph processing on the contribution degree data 1028, and displays a description on the screen of the output device 1004 via the screen output unit 1037. A screen example will be described later with reference to FIG. 11. Here, the description may be a graph display such as a factor contribution degree display 1105, or a template for interpreting the contribution degree data 1028 may be prepared in advance and text-based information may be provided according to the template. When the information is directly input to a machine without human intervention, the screen output in step S912 can be canceled.

### Condition Determination Based on Upper Bound 1021 According to Embodiment 1

FIG. 10 is a diagram showing an outline of condition determination based on the upper bound 1021 according to Embodiment 1. FIG. 10 shows the outline of the condition determination based on the upper bound in steps S906 to S909 in FIG. 9.

Each node in first to third layers includes condition 101 and a calculated value 102. The condition 101 is a relaxation condition or a fixing condition. The fixing condition is a condition for fixing a part of a variable of an optimization problem. The calculated value 102 is a KPI of an upper bound or an executable solution of the optimization problem.

First, in the first layer, the upper bound in the optimization problem in which all the integer constraints are relaxed is shown as the calculated value 102. In a search that is deeper than the first layer, the variables are fixed and the conditions are made stricter, so that no upper bound or executable solution has a KPI greater than 36. The first layer is not necessarily required.

Next, the upper bound of the search initial condition 1023 obtained in step S906 is shown in the second layer. At this time, it is not possible to determine which one contains the optimal solution. Further, in the third layer, the executable solution is obtained in the search in step S907. As a result of solving the relaxation problem, there is a node that is an upper bound and an executable solution when an integer constraint is satisfied.

Here, as an example of the branch-and-bound method, in addition to the condition of “fixing the employee A to the workplace 1”, “the employee B is fixed to the workplace 1 or not” is a variable to be fixed next. Then, beyond the condition of “the employee A is allocated to a workplace other than the workplace 1”, the next fixed variable is “the employee A is fixed to the workplace 2 or not”.

The processing of step S908 is described below.

First, it is assumed that an executable solution is obtained under the condition that “the employee A is fixed to the workplace 1” and the “employee B is allocated to a workplace other than the workplace 1”, and the KPI is 33. Next, if the upper bound of the condition that “the employee A is allocated to a workplace other than the workplace 1” in the second layer is the KPI: 32, the executable solution of the condition that “the employee A is fixed to the workplace 1” is better than any executable solution under the condition that “the employee A is allocated to a workplace other than the workplace 1”. Therefore, in step S909, it is determined that the optimal solution is under the condition that “the employee A is allocated to the workplace 1”, and “1” is output to the objective variable 803 of the contribution degree calculation data 1027.

Here, since the general branch-and-bound method is an algorithm for obtaining the optimal solution itself, since the upper bound that “the employee A is fixed to the workplace 1” and “the employee B is fixed to the workplace 1” is the KPI: 34, there is a chance that a solution better than the current executable solution is present, and therefore, a further search is performed. Initial branching in the second layer is essentially random. However, in order to describe the optimal plan, it is sufficient to determine whether there is an optimal solution under the focus state condition. Therefore, it is possible to make the calculation efficient by obtaining the upper bound in the initial condition 405 of the focus state of the user in step S906 and terminating the search according to the condition determination in step S908.

### Input and Output Screen According to Embodiment 1

FIG. 11 is a diagram showing an example of an input and output screen according to Embodiment 1. FIG. 11 shows an example of an interface through which the user inputs and outputs data required for the question and description generation, and the description of the optimal plan. The interface includes a proposed plan display 1101 for displaying the calculated plan 1011, a question sentence input form 1102 for inputting a question sentence, a factor contribution degree display 1105 for displaying a contribution degree of a factor for the optimal plan, and a contribution degree calculation data 1106.

The question sentence input form 1102 receives as a user input of the question sentence 401 in which the type (corresponding to an element 1102a), the target allocation 403 (corresponding to an element 1102b), and the reason type 404 (corresponding to an element 1102c) can be determined. The question sentence input form 1102 generates the question data 1024 in step S901 (FIG. 9) based on the user input. The interface of the description target element 402 is preferably in the form of a pull-down or a conditional expression, and is not limited thereto. When the description target element 402, the target allocation 403, and the reason type 404 are input and the analysis target data button 1103 is pressed, the analysis target data is uploaded to the plan analysis system 1. When an analysis start button 1104 is pressed, analysis processing of analyzing the description of the optimal solution is executed based on the uploaded analysis target data.

In the factor contribution degree display 1105, the contribution degree of each input factor is stacked and displayed, so that the overall tendency can be grasped. When the contribution degree according to the Shapley value is presented in the factor contribution degree display 1105, a reference value indicates whether the focus state condition is satisfied in a state in which all the input factors to be analyzed are relaxed.

The contribution degree calculation data 1106 can support the analysis of what combination of factors (constraints) results in the condition of the question (objective variable) being satisfied.

With reference to the factor contribution degree display 1105 in FIG. 11, for example, as for the “reason why the employee A is allocated to the workplace 1”, it can be seen that the factor extracted is “the contribution degree of the headcount constraint at the workplace 2 is +0.7, the contribution degree of the headcount constraint at a workplace 3 is +0.4, and the contribution degree of the headcount constraint at the workplace 1 is −0.1, which sums to a proposed plan 1. Therefore, due to the headcount constraints at the workplace 2 and the workplace 3, the employee A cannot be allocated to the workplace 2 or the workplace 3 other than the workplace 1.”

The plan optimization is a framework that outputs a solution that maximizes the KPI while taking into account the influence by various elements. However, extracting these influencing relationships one by one through trial and error is a time-consuming task. Therefore, the narrowing of the factor based on the contribution degree of the present embodiment can contribute to efficient analysis of the plan.

As in the present embodiment, when the contribution degree based on the Shapley value is applied to the objective variable indicated by the presence or absence of the condition that “the employee A is allocated to the workplace 1”, the contribution degree can be interpreted as a probability for the condition satisfaction. Since a main factor can be extracted based on a quantitative index referred to as the contribution degree, even if the contribution degree itself is difficult to be interpreted, more efficient analysis can be achieved by paraphrasing it using existing description templates or the like.

However, as the number of input factors of the plan increases, there is a case in which the optimization pattern 1026 becomes enormous and calculation of the contribution degree calculation data 1027 becomes difficult. Therefore, according to the present embodiment, the search initial condition 1023 is generated based on the focus state condition of the user, and the search for the solution is completed when the executable solution 1022 of each condition exceeds the upper bound 1021 of another condition. Accordingly, it is possible to obtain an exact description while reducing a calculation time of each pattern.

### Embodiment 2

In Embodiment 1, the basic configuration and processing are described. Further speedup is expected by combining histories of the optimization calculation. By completing the calculation early and obtaining an approximate solution, it is possible to reduce the number of combinations of input factors in the exact solution method described above.

Therefore, in Embodiment 2, a method for enabling utilization of a provisional solution of the optimal plan and generation of an approximate description will be described. In the following description of Embodiment 2, differences from Embodiment 1 will be mainly described, and a description of the same configurations and processing as those of Embodiment 1 will be omitted.

### System Configuration of Plan Analysis System According to Embodiment 2

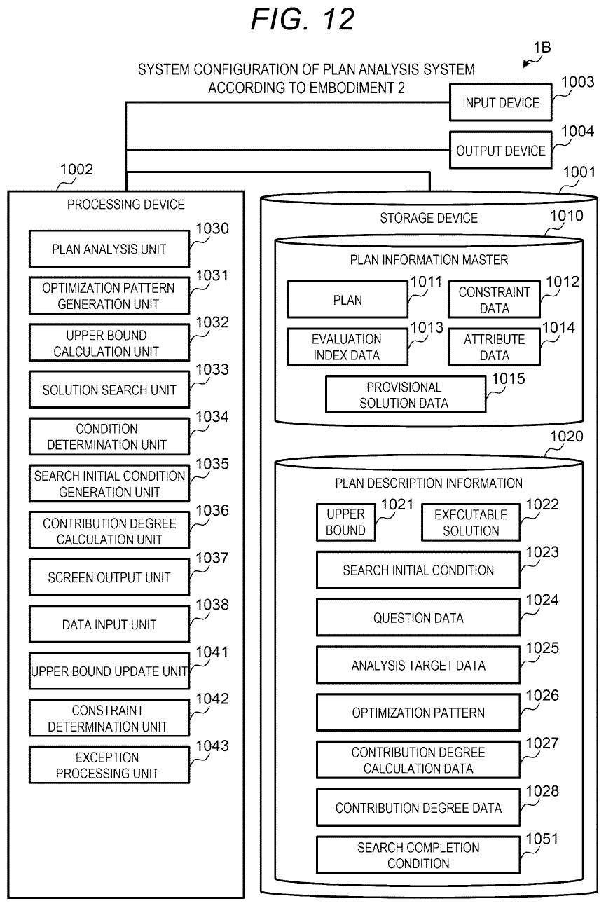

FIG. 12 is a diagram showing an example of a system configuration of a plan analysis system 1B according to Embodiment 2.

As compared with the plan analysis system 1 (FIG. 1) according to Embodiment 1, provisional solution data 1015 in the plan information master 1010 in the storage device 1001 and a search completion condition 1051 in the plan description information 1020 are added. An upper bound update unit 1041, a constraint determination unit 1042, and an exception processing unit 1043 of the processing device 1002 are added. The provisional solution data 1015 has a data structure similar to that of the upper bound 1021 and the executable solution 1022.

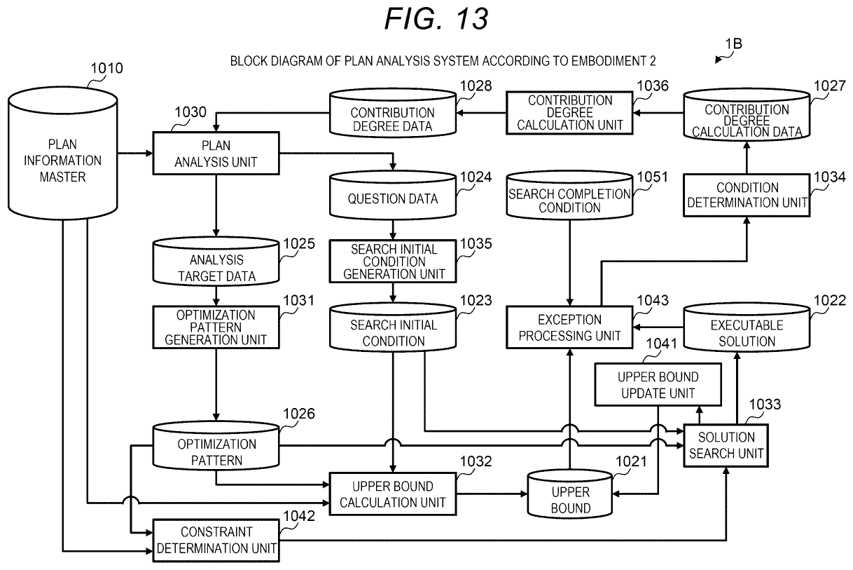

FIG. 13 is a block diagram showing an example of a functional configuration of the plan analysis system 1B according to Embodiment 2.

The following points are different from the plan analysis system 1 according to Embodiment 1 (FIG. 2). The constraint determination unit 1042 extracts, from among the executable solutions 1022 included in the provisional solution data 1015 of the plan information master 1010, ones that can be executed in the target optimization pattern 1026. If a provisional solution having a higher KPI value can be extracted, it may be possible to complete the search for a solution in a short period of time. After calculating all upper bounds in each layer of the search process for each search initial condition 1023, the upper bound update unit 1041 performs processing of updating from the original upper bound 1021. Since the upper bound becomes smaller as the search progresses, the possibility that the executable solution exceeds the upper bound of another condition is increased by adding the update processing. When the condition of the search completion condition 1051 is satisfied before the condition determination unit 1034 performs the determination, the exception processing unit 1043 performs processing of forcibly completing the search for the solution.

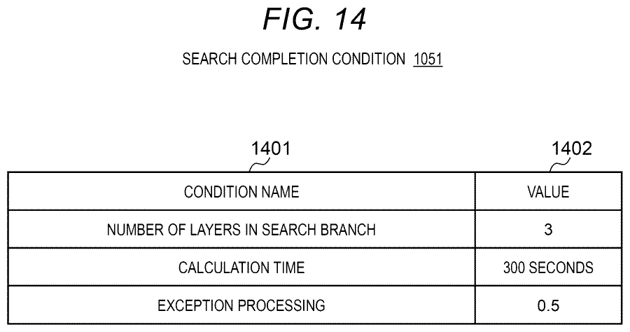

FIG. 14 is a diagram showing an example of a data structure of a search completion condition 1051 according to Embodiment 2. The search completion condition 1051 includes columns of a condition name 1401 and a value 1402. The condition name 1401 indicates a name of a condition for forcibly completing the search, or “exception processing” to be output when the search is completed. The value 1402 indicates values of each condition and exception processing.

### Description Generation Processing Based on Upper Bound According to Embodiment 2

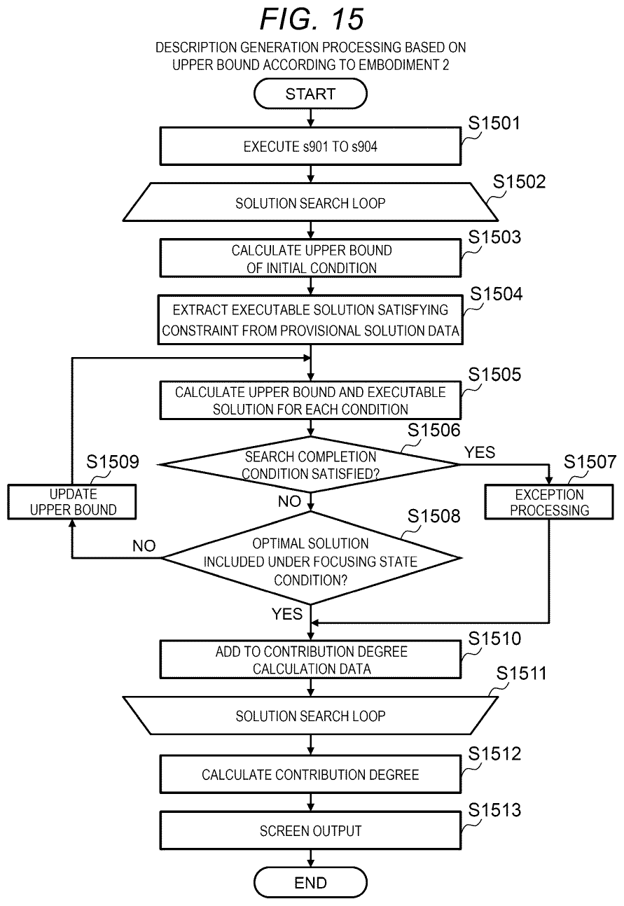

FIG. 15 is a diagram showing an example of a flowchart showing description generation processing based on an upper bound according to Embodiment 2. Hereinafter, a difference from the description generation processing based on the upper bound according to Embodiment 1 (FIG. 9) will be mainly described.

Step S1501: The plan analysis unit 1030 performs the processing of steps S901 to S904 of FIG. 9 to obtain the search initial condition 1023 and the optimization pattern 1026. However, the optimization pattern 1026 of the input factor is generated in order from a combination including more constraint conditions.

Step S1502: A solution search loop of steps S1503 to S1511 is executed for each row of the optimization pattern 1026.

Step S1503: The upper bound calculation unit 1032 calculates the upper bound 1021 for the search initial condition 1023 based on the plan information master 1010.

Step S1504: The constraint determination unit 1042 extracts, from among the executable solutions 1022 included in the provisional solution data 1015 of the plan information master 1010, ones that can be executed in the target optimization pattern 1026. The extraction method can utilize existing methods such as determining based on a combination of constraints or actually solving an optimization problem. By generating in order from a combination including more constraint conditions in step S1501, there is a high possibility that the provisional solution data 1015 executable in a complicated pattern than the target optimization pattern 1026 is obtained as a history in advance. Therefore, it can be expected that the number of combinations that can be completed by using the history before the solution search is increased.

Step S1505: The solution search unit 1033 searches for the executable solution 1022 in each search initial condition 1023 based on the plan information master 1010. When the executable solution is obtained in step S1504, the solution search unit 1033 proceeds the processing to step S1506 without searching for a solution in step S1505.

Step S1506: The exception processing unit 1043 determines whether the search completion condition 1051 is satisfied. For example, as shown in FIG. 14, the exception processing unit 1043 determines whether a condition for forcibly completing a solution search such as a calculation time of more than 300 seconds, in which the number of layers to be searched for is more than 3, is satisfied. When the search completion condition 1051 is satisfied (YES in step S1506), the exception processing unit 1043 proceeds the processing to step S1507. On the other hand, when the search completion condition 1051 is not satisfied (NO in step S1506), the exception processing unit 1043 proceeds the processing to step S1508.

Step S1507: The exception processing unit 1043 outputs the value 1402 of the exception processing of the search completion condition 1051 as the execution result of the exception processing. The value 1402 of the exception processing is used for the objective variable 803 of the contribution degree calculation data 1027.

Step S1508: The condition determination unit 1034 determines whether an optimal solution is included in the focus state condition based on the upper bound 1021 and the executable solution 1022 obtained in step S1510. When the optimal solution is included in the focus state condition (YES in step S1508), the condition determination unit 1034 proceeds the processing to step S1510, and when the optimal solution is not included in the focus state condition (NO in step S1508), the condition determination unit 1034 proceeds the processing to step S1509.

Step S1509: The upper bound update unit 1041 updates the upper bound of each search initial condition 1023. For updating, it is necessary to calculate all the upper bounds of certain layers in the solution search. If it is calculated, the largest upper bound in that layer is defined as a new upper bound of the search initial condition 1023. For example, in FIG. 10, when the search reaches the second layer, the upper bound under the condition that “the employee A is allocated to a workplace other than the workplace 1” is 32. Here, assuming that all the branches of the third layer are completed (the employee A is allocated to the workplace 2 or is not), it is clear that no solution larger than 30 can be obtained in the layers thereafter, and thus the upper bound that “the employee A is allocated to a workplace other than the workplace 1” can be updated to 30, which is the largest value in the third layer. Accordingly, the possibility that the executable solution of “allocating the employee A to the workplace 1” exceeds the upper bound of “allocating the employee A to a workplace other than the workplace 1” is increased.

Step S1510: The condition determination unit 1034 reflects the result determined in step S1507 and step S1508 in the contribution degree calculation data 1027.

Step S1511: When steps S1503 to S1510 are executed on all the optimization patterns 1026 and the output to the contribution degree calculation data 1027 is completed, the processing proceeds to step S1512. At each time point when the execution of steps S1503 to S1510 is completed for each optimization pattern 1026, the upper bound 1021 and the executable solution 1022 are held as the provisional solution data 1015.

Step S1512: The contribution degree calculation unit 1036 calculates the contribution degree data 1028 for each analysis target based on the contribution degree calculation data 1027.

Step S1513: The plan analysis unit 1030 performs processing such as graph processing in the contribution degree data 1028 in the same manner as in step S912 (FIG. 9), and displays a description on the output device 1004 via the screen output unit 1037. A screen example is different from the screen example according to Embodiment 1 shown in FIG. 11 in that the screen according to the present embodiment receives the input of the condition name 1401 of the search completion condition 1051 and outputs the value 1402, but is otherwise identical. When the information is directly input to a machine without human intervention, the screen output in step S1513 can be canceled.

The constraint determination unit 1042 effectively utilizes the result of existing combination calculation, and the upper bound update unit 1041 gradually reduces the upper bound, thereby speeding up the search for the solution. It is also effective to tune the solution search unit 1033 in a direction in which the upper bound is updated, that is, to preferentially perform a breadth-first search that prioritizes the same hierarchy over a depth-first search that prioritizes deeper hierarchies.

In addition, by skipping the calculation of a difficult combination using the exception processing unit 1043, it is possible to grasp the overall tendency approximately in a short time. In the case of the contribution degree based on the Shapley value, even if it is replaced with 0.5 in the exception processing, a magnitude relationship of the contribution degree between factors will not be reversed, and thus it is possible to efficiently extract at least strong factors that are thought to have an influence. First, a method for extracting factors by an approximate solution and then proceeding to calculation of an exact contribution degree can be considered.

As described above, Embodiment 2 is suitable for grasping the overall tendency of the contribution, and Embodiment 1 can calculate the contribution in a more detailed form. It is assumed that the detailed information is output in Embodiment 1 after large-scale data is processed in Embodiment 2.

### Embodiment 3

In Embodiment 3, in order to further reduce calculation cost of the optimization pattern 1026, a method for performing the description generation by efficiently solving a relaxation problem based on an inverse constraint will be described. In the following description of Embodiment 3, differences from Embodiment 1 will be mainly described, and description of the same configurations and processing as those of Embodiment 1 will be omitted.

### System Configuration of Plan Analysis System 1C According to Embodiment 3

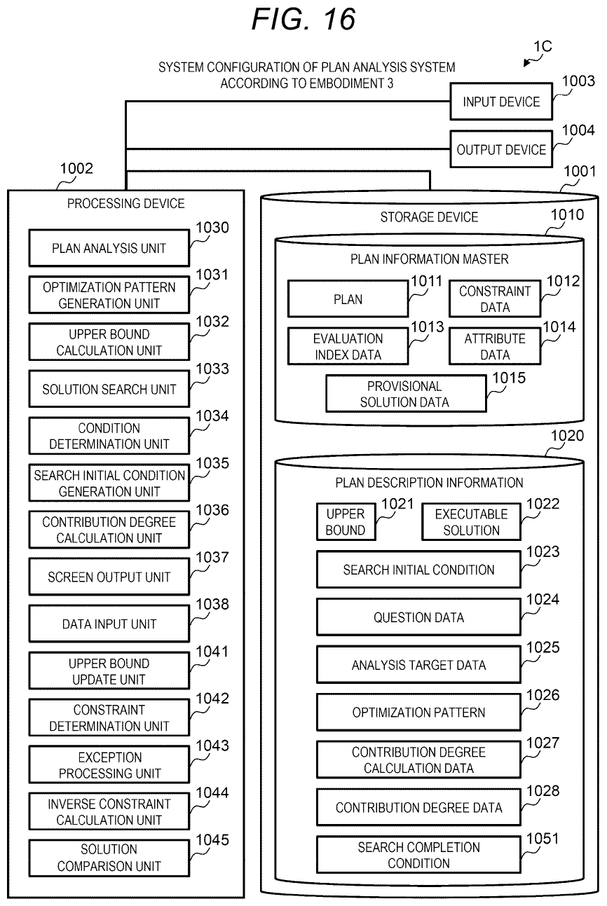

FIG. 16 is a diagram showing an example of a system configuration of a plan analysis system 1C according to Embodiment 3.

The plan analysis system 1C further includes an inverse constraint calculation unit 1044 and a solution comparison unit 1045 in the processing device 1002, as compared with the plan analysis system 1B according to Embodiment 2 (FIG. 12).

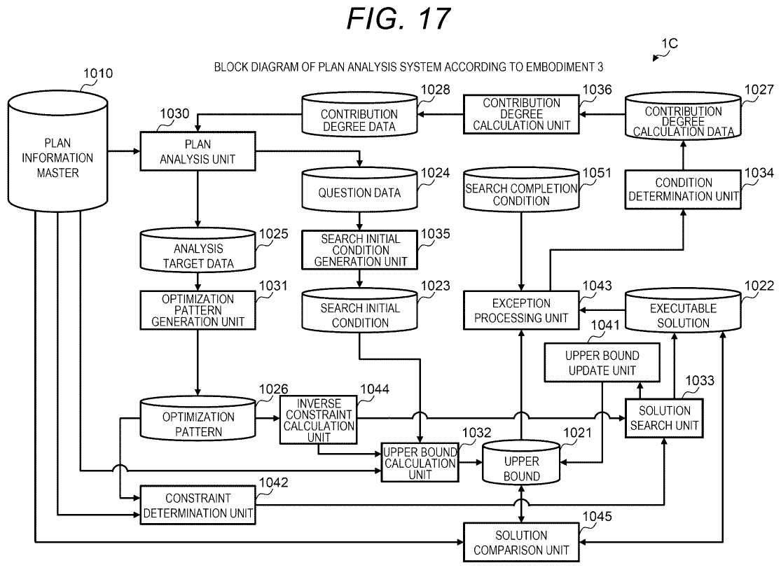

FIG. 17 is a block diagram showing an example of a functional configuration of the plan analysis system 1C according to Embodiment 3.

The plan analysis system 1C includes the inverse constraint calculation unit 1044 as compared with the plan analysis system 1B according to Embodiment 2 (FIG. 13). The inverse constraint calculation unit 1044 calculates a constraint condition (inverse constraint) that is the opposite of an original condition for a constraint (excluded constraint) that is turned OFF in the optimization pattern 1026. The inverse constraint is a constraint obtained by reversing the sign of the parameter 503 for each constraint indicated by the target name 502 in the example shown in the analysis target data 1025 (FIG. 2). Specifically, when the target name 502 is “the headcount constraint of the workplace 1”, a reversed sign of a forward constraint “≤2” becomes “>2,” which is the inverse constraint. When the target name 502 is the “allocation constraint of the workplace 1”, the reversed sign of a forward constraint “=1” becomes “1”, which is the inverse constraint.

The solution comparison unit 1045 compares the upper bound 1021 and the executable solution 1022 obtained under the inverse constraint with the provisional solution data 1015 under the target constraint (forward constraint), and outputs a solution having a larger KPI.

### Description Generation Processing According to Embodiment 3

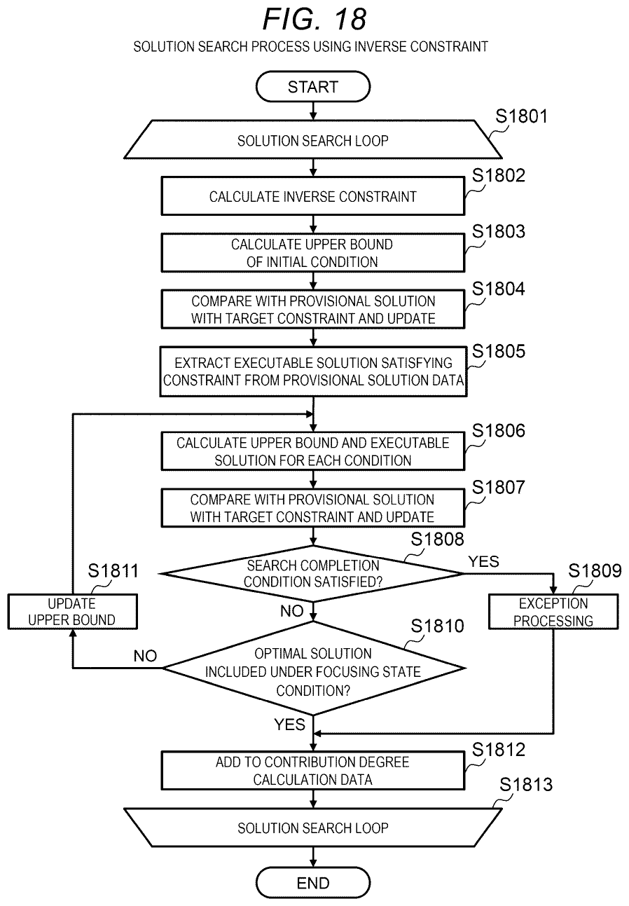

FIG. 18 is a diagram showing an example of a flowchart showing description generation processing according to Embodiment 3. Differences from the description generation processing according to Embodiment 2 will be described.

Step S1801: The solution search loop of steps S1802 to S1813 is executed for each row of the optimization pattern 1026. As in step S1501 (FIG. 15), the optimization pattern 1026 of the input factor is generated in order from a combination including more constraint conditions.

Step S1802: The inverse constraint calculation unit 1044 calculates a constraint condition (inverse constraint) that is the opposite of an original condition for a constraint that is turned OFF in the optimization pattern 1026. For example, in the case of “the headcount constraint of the workplace 2” in FIG. 5, the inverse constraint is to “allocate more than two employees in the workplace 2”.

Step S1803: The upper bound calculation unit 1032 calculates the upper bound 1021 for the search initial condition 1023 based on the plan information master 1010 reflecting the inverse constraint.

Step S1804: The solution comparison unit 1045 compares the upper bound 1021 and the executable solution 1022 obtained under the inverse constraint in step S1803 with the provisional solution data 1015 with the target constraint, and outputs a solution having a larger KPI. For example, when only the “headcount constraint of the workplace 2” in FIG. 5 is turned OFF and the upper bound is calculated based on the inverse constraint of “allocating more than two employees in the workplace 2”, the upper bound when “the headcount constraint of the workplace 2” is also turned ON is extracted from the provisional solution data 1015. Then, the upper bounds are compared, and the larger one is set as the upper bound under the condition.

Step S1805: the processing is the same as that in step S1504. Here, the inverse constraint is not used.

Step S1806: The solution search unit 1033 searches the executable solution 1022 in each search initial condition 1023 based on the plan information master 1010 reflecting the inverse constraint. When the executable solution is already obtained in step S1504, the solution search unit 1033 proceeds the processing to step S1506 without searching for the optimal solution.

Step S1807: Similarly to step S1804, the solution comparison unit 1045 compares the upper bound 1021 and the executable solution 1022 obtained in the search processing of step S1806 with the provisional solution data 1015 with the target constraint, and outputs a solution having a larger KPI. The same provisional solution data 1015 is also used for the fixed element 601 (FIG. 6).

Steps S1808 to S1813 are the same as steps S1506 to S1511.

In the present embodiment, by using the inverse constraint, it is possible to search for only a solution space added when the original constraint-ON condition is changed to the constraint-OFF condition. Accordingly, a search space for the relaxation problem is narrowed, and the solution can be efficiently obtained.

Although the embodiments according to the present disclosure are described in detail above, the present disclosure is not limited to the above-described embodiments, and various modifications can be made without departing from the gist thereof. For example, the embodiments described above are described in detail to facilitate understanding of the invention, and the invention is not necessarily limited to those including all the configurations described above. In addition, another configuration can be added to, deleted from, or replaced with a part of a configuration of each embodiment.

Some or all of the configurations, functional units, processing units, and the like described above may be implemented by hardware by, for example, designing with an integrated circuit. In addition, the configurations, functions, and the like described above may be implemented by software by a processor interpreting and executing a program for implementing each function. Information such as a program, a table, and a file for implementing each function can be stored in a storage device such as a memory, HDD, and SSD, or in a recording medium such as an IC card, an SD card, and a DVD.

In addition, in each drawing described above, control lines and information lines that are considered necessary for description are shown, and not all the control lines and information lines on implementation are necessarily shown. For example, it may be considered that almost all configurations are actually interconnected.

The above-described processing functions and data arrangement form are merely examples. The arrangement form of each processing function and data can be changed to an optimal arrangement form from the viewpoint of the performance, processing efficiency, communication efficiency, and the like of hardware and software.

What is claimed is:

1. A plan analysis method to be executed by a plan analysis system that analyzes an optimal plan in which an optimization target is optimized based on a plurality of constraints and evaluation indices,
the plan analysis system including a processor and a memory,
the plan analysis method comprising the processor executing the following processing:
generating a plurality of optimization patterns by combining the constraints to be analyzed;
calculating, for each of the optimization patterns, an upper bound based on the evaluation indices when a condition corresponding to a focus state that a user pays attention to in the optimal plan is satisfied and the upper bound when the condition is not satisfied;
searching for an executable solution for the optimization under each of the conditions; and
determining, based on the upper bound and the executable solution, whether an optimal solution for the optimization is present under the conditions.

2. The plan analysis method according to claim 1, further comprising the processor executing the following processing:
determining, based on the focus state, an initial condition for calculating the upper bound and searching for the executable solution.

3. The plan analysis method according to claim 1, further comprising the processor executing the following processing:
holding the upper bound and the executable solution in each of the conditions, and outputting information indicating that a certain condition among the conditions is satisfied in the optimal solution when the executable solution in the certain condition exceeds the upper bound in another condition.

4. The plan analysis method according to claim 1, further comprising the processor executing the following processing:
searching for the executable solution under the condition to which a new condition is added in a search process of the executable solution; and
updating the upper bound based on the condition to which the new condition is added.

5. The plan analysis method according to claim 3, further comprising the processor executing the following processing:
when a completion condition of the search for the executable solution is satisfied, completing the search for the executable solution, executing predetermined exception processing, and outputting an execution result of the exception processing instead of outputting the information.

6. The plan analysis method according to claim 1, further comprising the processor executing the following processing:
generating the optimization patterns in an order including more constraints among the plurality of constraints.

7. The plan analysis method according to claim 1, further comprising the processor executing the following processing:
determining whether the executable solution already acquired in another optimization pattern satisfies the condition in the target optimization pattern, and when the condition is satisfied, holding the executable solution as a provisional solution in the target optimization pattern.

8. The plan analysis method according to claim 1, further comprising the processor executing the following processing:
executing a breadth-first search when searching for the executable solution.

9. The plan analysis method according to claim 1, further comprising the processor executing the following processing:
calculating an inverse constraint for an excluded constraint that is the constraint excluded in the optimization pattern;
searching for the executable solution for the optimization pattern by using the inverse constraint; and
comparing the upper bound or the executable solution acquired during the search for the executable solution with the upper bound or the executable solution under the same condition among the upper bound or the executable solution obtained for the optimization pattern including the excluded constraint, and determining the upper bound or the executable solution with a larger value as the upper bound or the executable solution under the condition.

10. The plan analysis method according to claim 1, further comprising the processor executing the following processing:
converting the optimization pattern and a determination result as to whether an optimal solution for the optimization is present under the condition for the optimization pattern into a feature and storing the feature in contribution degree calculation data; and
calculating, based on the feature, a contribution degree of each of the constraints for the optimal plan.

11. The plan analysis method according to claim 10, further comprising:
generating, by the processor, a description for the focus state based on the contribution degree and outputting a result through an output device.

12. The plan analysis method according to claim 11, further comprising the processor executing the following processing:
receiving a user input of information related to generation of the description via an input device.

13. A plan analysis system that analyzes an optimal plan in which an optimization target is optimized based on a plurality of constraints and evaluation indices, comprising:
an optimization pattern generation unit configured to generate a plurality of optimization patterns by combining the constraints to be analyzed;
an upper bound calculation unit configured to calculate, for each of the optimization patterns, an upper bound based on the evaluation indices when a condition corresponding to a focus state that a user pays attention to in the optimal plan is satisfied and the upper bound when the condition is not satisfied;
a solution search unit configured to search for an executable solution for the optimization under each of the conditions; and
a condition determination unit configured to determine, based on the upper bound and the executable solution, whether an optimal solution for the optimization is present under the conditions.
